(19) United States
(12) Patent Application Publication
(10) Pub. No.: US 2008/0272646 A1
(43) Pub. Date: Nov. 6, 2008

(54) HYDRAULIC APPARATUS FOR FLUID PRESSURE CONTROL

(75) Inventors: Chiharu Nakazawa, Kawasaki-shi (JP); Kazuya Terashima, Isehara-shi (JP); Katsuma Tsuruoka, Atsugi-shi (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/112,629

(22) Filed: Apr. 30, 2008

(30) Foreign Application Priority Data
May 1, 2007 (JP) 2007-120946

(51) Int. Cl. B60T 8/60

(52) U.S. Cl. 303/155

(57) ABSTRACT

A hydraulic apparatus includes a fluid pressure control unit which includes: a housing unit enclosing a pump, a motor fixed to a first side surface of the housing unit; a control section provided on a second side surface of the housing unit and arranged to control the motor; and a physical quantity sensor fixed to the control section. There are further provided a plurality of mount portions to support the housing unit to a vehicle body elastically. The physical quantity sensor is located between the mount portions.

### BACKGROUND OF THE INVENTION

The present invention relates to hydraulic apparatus (such as hydraulic apparatus for a brake system of a vehicle), and a supporting structure for a fluid pressure control unit.

A published Japanese patent application, Publication No. 2006-56406 shows a brake pressure control unit including a control housing enclosing a control section and an acceleration sensor mounted on the control section, and a pump body including a pump.

### SUMMARY OF THE INVENTION

The above-mentioned brake pressure control unit might allow vibrations of the pump to be transmitted to the acceleration sensor, and tend to deteriorate the sensing accuracy of the acceleration sensor.

Therefore, it is an object of the present invention to provide hydraulic apparatus for restraining sensing errors in a sensor.

According to one aspect of the present invention, a hydraulic apparatus comprises a fluid pressure control unit which comprises: a housing unit enclosing a pump, and including a first side surface on a first side, and a second side surface on a second side opposite to the first side; a motor fixed to the first side surface of the housing unit and arranged to drive the pump; a control section disposed on the second side of the housing unit and arranged to control the motor; a cover covering the control section; a physical quantity sensor fixed to the control section, placed between the housing unit and the cover, and arranged to sense a physical quantity of a vehicle; and a plurality of mount portions to mount the housing unit to a vehicle body elastically, the physical quantity sensor being located between the mount portions.

According to another aspect of the invention, a hydraulic apparatus comprises: a housing unit including a pump, a first side surface on a first side, and a second side surface on a second side opposite to the first side; a motor which is fixed to the first side surface of the housing unit and which includes a rotary member rotating about a motor axis extending in a first direction, to drive the pump; a second side section fixed to the second side surface of the housing unit and including a control section to control the motor and a physical quantity sensor disposed on the second side of the housing unit and arranged to sense a physical quantity; and a pair of a first side mounting device to support the housing unit elastically on the first side and a second side mounting device to support the housing unit elastically on the second side, at least one of the first and second side mounting devices being arranged to support the housing unit at two separate mount points which are spaced apart from each other in a second direction perpendicular to a first imaginary plane containing the motor axis, the physical quantity sensor being located, in the first direction, between the first side mounting device and the second side mounting device, and located, in the second direction, between the separate mount points on both sides of the first imaginary plane.

### BRIEF DESCRIPTION OF THE DRAWINGS

FIG. 1 is a hydraulic circuit diagram showing a brake system according to a first embodiment of the present invention.

FIG. 2 is a sectional view of a fluid pressure control unit shown in FIG. 1.

FIGS. 3A and 3B are views showing a piston pump shown in FIG. 2.

FIGS. 4A and 4B are views showing a support structure of the fluid pressure control unit of FIG. 2. FIG. 4A is a side view as viewed in a (second) direction of a pump axis. FIG. 4B is a bottom view as viewed from a lower side.

FIG. 5 is a bottom view showing a support structure of a fluid pressure control unit according to a first variation of the first embodiment.

FIGS. 6A and 6B are side view and bottom view showing a support structure of a fluid pressure control unit according to a second variation of the first embodiment.

FIG. 7 is a side view showing a support structure of a fluid pressure control unit according to a second embodiment.

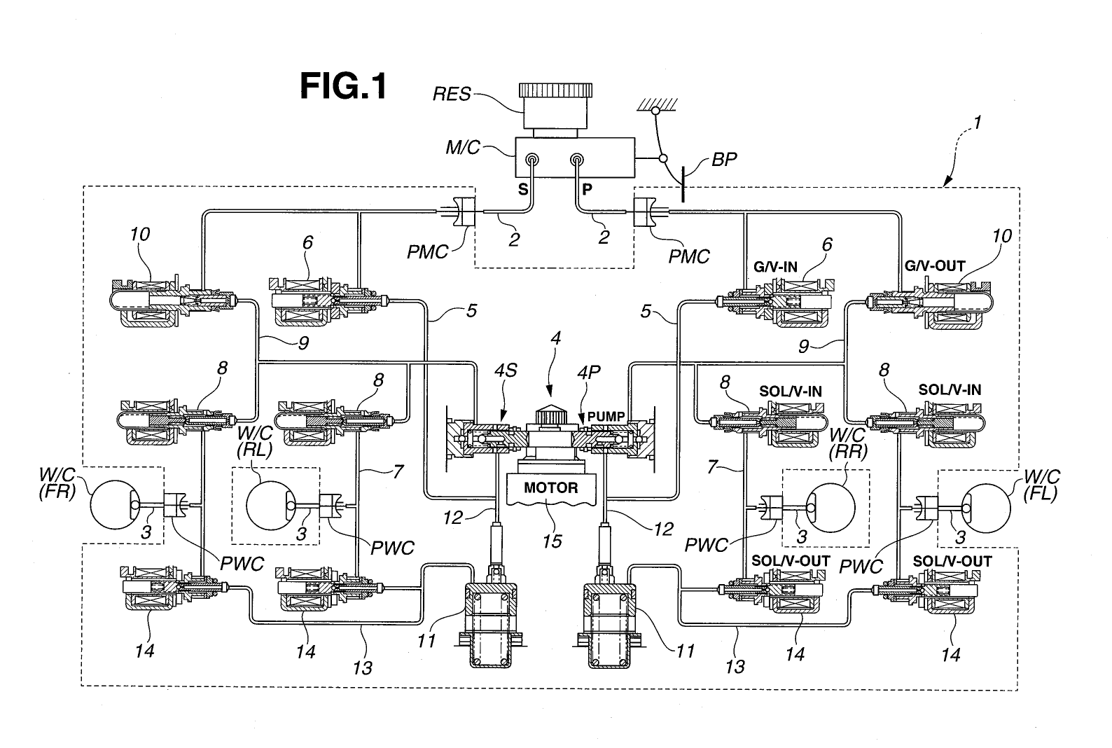

### DETAILED DESCRIPTION OF THE INVENTION

[Arrangement of Brake Piping] FIG. 1 is a hydraulic circuit diagram showing a brake system according to a first embodiment of the present invention. This brake system can produce a brake pressure with a piston pump 4 driven by a motor 15, separately from a brake pressure produced by a master cylinder M/C in accordance with a depressing force applied on a brake pedal BP. The brake system can produce a braking force for braking a vehicle by supplying the brake pressure thus produced by pump 4 to wheel cylinders W/C of the vehicle. Furthermore, the brake system controls the brake fluid pressure in accordance with a command pressure determined by a controller to achieve a vehicle dynamics control (referred to as VDC) and/or an anti-lock brake system (referred to as ABS).

This brake system includes two brake pressure hydraulic circuits, a P route hydraulic circuit and an S route hydraulic circuit, arranged in a so-called X piping arrangement. The P route circuit is connected to wheel cylinder W/C(FL) for a front left wheel of the vehicle, and wheel cylinder W/C(RR) for a rear right wheel. The S route circuit is connected to wheel cylinder W/C(FR) for a front right wheel, and wheel cylinder W/C(RL) for a rear left wheel. The piston pump 4 of this example is composed of a first (P side) piston pump 4P for the P route circuit, and a second (S side) piston pump 4S for the S route circuit. These two piston pumps 4P and 4S are driven by the single motor 15. As shown in FIG. 1, the P and S route circuits are substantially the same in the construction, and these circuits are arranged symmetrically in the circuit diagram of FIG. 1 though these circuits are not necessarily symmetrical in the actual arrangement in the vehicle.

A fluid pressure or hydraulic pressure control unit 1 (shown by a broken line in FIG. 1) is connected with master cylinder M/C by brake lines 2 in the form of brake pipes in this example, and further connected with wheel cylinders W/C, respectively, by brake lines 3 in the form of brake pipes in this example. Pressure control unit 1 includes master cylinder ports PMC to which the brake pipes 2 are attached, respectively, and wheel cylinder ports PWC to which the brake pipes 3 are attached, respectively. In this example, master cylinder M/C has two ports, one being a P side port and the other being an S side port, and there are two of the master cylinder ports PMC, one being a P side port PMC for connecting the P course circuit with the P side port of master cylinder M/C by the P side pipe 2, and the other being an S side port PMC for connecting the S course circuit with the S side port of master cylinder M/C by the S side pipe 2, as shown in FIG. 1. Four of the wheel cylinder ports PWC of pressure control unit 1 are connected, respectively, with the four wheel cylinders W/C by the four pipes 3, as shown in FIG. 1.

Each of the P and S circuits includes a fluid passage 5 and a gate-in valve 6 disposed in the fluid passage 5. Fluid passage 5 connects the master cylinder port PMC with the inlet side of the piston pump 4 (4P or 4S). Gate-in valve 6 is a normally-closed solenoid valve.

Each of the P and S circuits includes a fluid passage 7 connecting the outlet side of the piston pump 4 (4P or 4S) with the wheel cylinders W/C, and a pressure increase valve 8 disposed in the fluid passage 7 for each wheel cylinder W/C. The pressure increase valves 8 are normally-open solenoid valves. The fluid passage 7 of this example includes a common section connected with the outlet of piston pump 4 (4P or 4S), a first branch section extending from the common section to a first one of the wheel cylinders W/C on this side (P side or S side), and a second branch section extending from the common section to a second one of the wheel cylinders on this same side. Pressure increase valves 8 are disposed, respectively, in the first and second branch sections of fluid passage 7.

Each of the P and S circuits includes a fluid passage 9 connecting the fluid passage 7 with master cylinder port PMC, and a gate-out valve 10 disposed in the fluid passage 9. Gate out valve 10 is a normally open solenoid valve. Fluid passage 9 is connected with the common section of fluid passage 7. Accordingly, the connection (or converging) point between fluid passage 9 and fluid passage 7 is located between piston pump 4 (4P or 4S) and the pressure increase valves 8.

Reservoir 11 is provided on the inlet side of piston pump 4 (4P or 4S) in each of the P and S circuits. Reservoir 11 is connected with piston pump 4 is connected by a fluid passage 12.

Each of the P and S circuits includes a fluid passage 13 connecting reservoir 11 with the wheel cylinders W/C, and a pressure decrease valve 14 for each wheel cylinder W/C. The pressure decrease valves 14 are normally closed solenoid valves. The fluid passage 13 of this example includes a common section connected with reservoir 11, a first branch section extending from the common section to a first one of the wheel cylinders W/C on this side (P side or S side), and a second branch section extending from the common section to a second one of the wheel cylinders on this same side. Pressure decrease valves 14 are disposed, respectively, in the first and second branch sections of fluid passage 13.

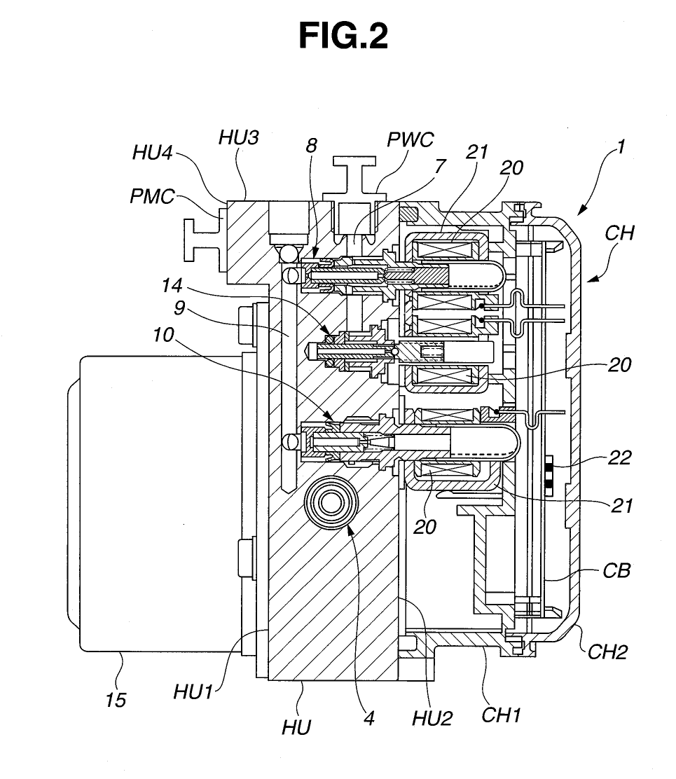

Any one or more of gate-in valves 6, gate-out valves 10, pressure increase valves 8 and pressure decrease valves 14 can be included, as an electromagnetic valve or a solenoid valve, in hydraulic apparatus according to the present invention.

[Construction of Fluid Pressure Control Unit] FIG. 2 shows the fluid pressure control unit 1 in section. Pressure control unit 1 includes a housing unit HU, a control housing CH and motor 15. Piston pump 4 (4P and 4S), gate-in valves 6, gate-out valves 10, pressure increase valves 8 and pressure decrease valve 14 are mounted on housing unit HU. Control housing CH includes a control board CB for controlling the motor 15, gate-in valves 6, gate-out valves 10, pressure increase valves 8 and pressure decrease valves 14.

Piston pump 4, gate-in valves 6, gate-out valves 10, pressure increase valves 8 and pressure decrease valves 14 are fixed to housing unit HU, by staking (or caulking) in this example. Housing unit HU has two opposite (first and second) side surfaces HU1 and HU2, and an upper surface HU3. Motor 15 is fixed to the first side surface HU1 (which is a left side surface as viewed in FIG. 2) on a first side (which is a left side in FIG. 2). Control housing CH is fixed to the second side surface HU2 (right side surface as viewed in FIG. 2) on a second side (right side in FIG. 2). Wheel cylinder ports PWC are provided in the upper surface HU3 which faces upwards when the pressure control unit 1 is installed in a vehicle. Housing unit HU further has an upper side surface HU4 located above the first side surface HU1. Master cylinder ports PMC are provided in the upper side surface HU4.

Control housing CH includes yokes 21, a support plate portion CH1, and a control cover CH2. Coils 20 for driving gate-in valves 6, gate-out valves 10, pressure increase valves 8 and pressure decrease valve 14 are fixed to yokes 20. Control board CB is mounted on support portion CH1. Support plate portion CH1 includes a support partition wall extending vertically as viewed in FIG. 2. In the assembled state of FIG. 2 in which the support plate portion CH1 is fixed to housing unit HU, the partition wall of support plate portion CH1 is located between the coils 20 and yokes 21 on the first side which is the left side in FIG. 1, and the control board CB on the second side which is the right side in FIG. 2. Therefore, coils 20 and yokes 21 are located between housing unit HU and the support partition wall of support plate portion CH1. Control board CB is supported on the opposite side (second side) of the support partition wall so that control board CB is separated by the support partition wall from the coils 20 and yokes 21. Control cover CH2 is fixed to support portion CH1 so as to close the opening of support plate portion CH1, and to protect control board CB between the support partition wall and control cover CH2.

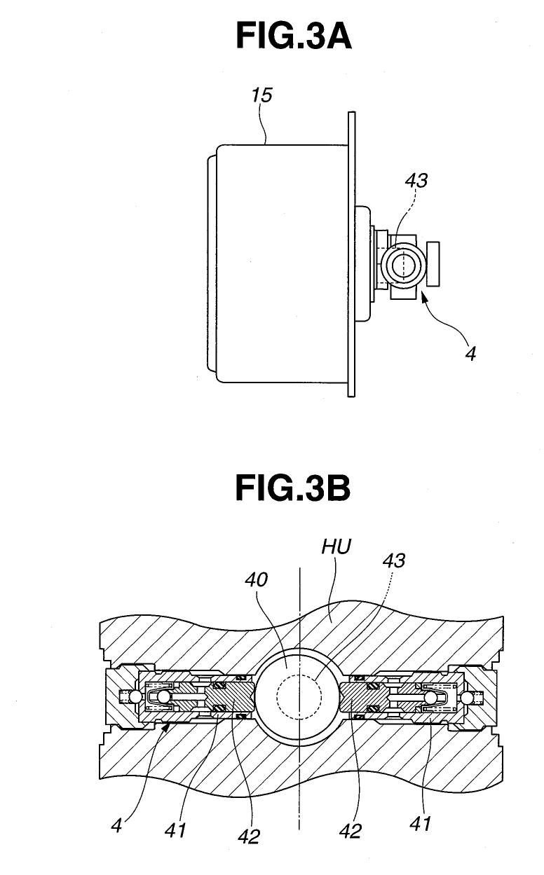

A sensing section 22 for sensing a vehicle motion variable is attached to control board CB. The motion variable sensing section 22 of this example includes a longitudinal acceleration sensor, a lateral acceleration sensor and a yaw rate sensor, which can serve as a physical quantity sensor.

[Construction of Piston Pump] FIGS. 3A and 3B show the construction of piston pump 4. FIG. 3A is a view as viewed from the axial direction of piston pump 4, and FIG. 3B is a partial longitudinal sectional view of piston pump 4 in the axial direction.

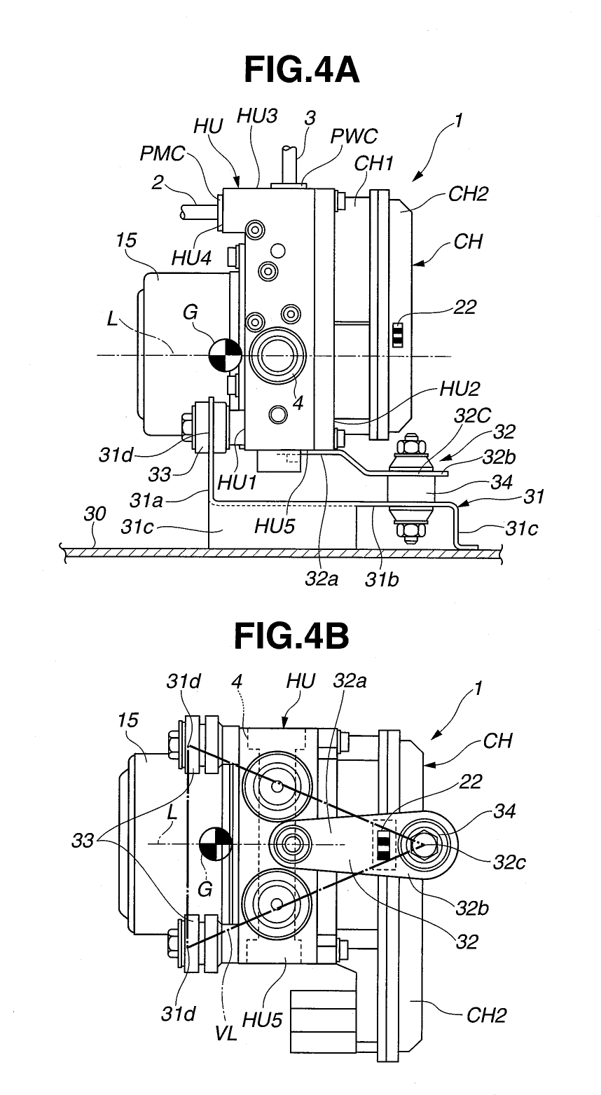

Piston pump 4 is disposed in housing unit HU. Piston pump 4 includes a cam 40 mounted on a shaft 43 of motor 15, and pistons 42 slidable in respective cylinders 41 in the axial direction, in accordance with the rotation of cam 40. Cam 40 is an eccentric cam fixedly mounted eccentrically on motor shaft 43. By the rotation of cam 40, the piston 42 on each side moves in the axial direction and thereby supplies the brake fluid toward the wheel cylinders W/C.

[Support Structure of Pressure Control Unit] FIGS. 4A and 4B show a support structure of pressure control unit 1. FIG. 4A is a view as viewed in the axial direction of piston pump 4 (which can correspond to a second direction). FIG. 4B is a bottom view as viewed from below, showing a lower surface HU5 facing downward when control unit 1 is installed in the vehicle. FIG. 4B shows the control unit 1 in the state in which a first bracket 31 shown in FIG. 4A is removed. Although the vehicle motion variable sensing section 22 is concealed in control cover CH2, FIGS. 4A and 4B show the position of vehicle motion variable sensing section 22 to facilitate the explanation.

The pressure control unit 1 is supported to a vehicle body 30 by first and second mounting brackets 31 and 32, as shown in FIG. 4A. First bracket 31 includes two vertical wall portions 31a extending along the first side surface HU1 of housing unit HU, and a horizontal wall portion 31b extending along the lower surface HU5 of housing unit HU. Vertical wall portions 31a and horizontal wall portion 31b are integral parts of a L-shaped plate or sheet as shown in FIG. 4A. First bracket 31 further includes flange portions 31c each including a leg portion extending downward from an end of horizontal wall portion 31b, and a flange end portion projecting outwards from the lower end of the leg portion. Flange portion 31c of first bracket 31 is fixed to vehicle body 30 by welding, or joining with fastening devices such as bolts. Upper end portions of vertical wall portions 31a of first brackets 31 are fixed to the first (left) side surface HU1 of housing unit HU, respectively, through mount rubber members 33 made of a resin. Thus, at first mount portions 31d located, respectively, at the upper end portions of vertical wall portions 31a, the pressure control unit 1 is fixed or supported elastically to the first bracket 31 through mount rubber members 33. Pressure control unit 1 supported at the first mount portions 31d in an axial direction L of motor 15 (corresponding to a first direction).

Second bracket 32 includes an upper (horizontal wall) portion 32a extending along the lower surface HU5 of housing unit HU, and a lower (horizontal wall) portion 32b projecting outwards at a lower level lower than the upper portion 32a. The upper portion 32a of second bracket 32 is fixed (rigidly) to the lower surface HU5 of housing unit HU. The lower portion 32b of second bracket 32 is fixed, at a second mount portion 32c, to the horizontal wall portion 31b of first bracket 31 elastically through a mount rubber member 34 made of a resin. The horizontal wall portion 31b of first bracket 31 extends from the lower ends of the vertical wall portions 31a to an outer end from which the flange portion 31c extends downwards. Second bracket 32 is fixed to the first bracket 31 at a position near the outer end of the horizontal wall portion 31b. As shown in FIG. 4A, the housing unit HU is located between the vertical wall portions 31a and the second mount portion 32c in the motor axis direction. At the second mount portion 32c, fluid pressure control unit 1 is supported in a second supporting direction which is perpendicular or orthogonal to a first supporting direction at the first mount portion 31d. The vertical wall portions 31a of first bracket 31 are fixed to the housing unit HU, respectively, through the mount rubber members 33, by fastening devices, such as bolts, extending in the first supporting direction which, in this example, extend in parallel to the motor axis L, as shown in FIGS. 4A and 4B. On the other hand, the second bracket 32 is fixed to the first bracket 31 through the rubber member 34 by a fastening device, such as a bolt, extending in the second supporting direction which, in this example, extends (vertically) in an up and down direction. In the example shown in FIG. 4A, the level of second mount portion 32c is lower than the level of the first mount portions 31d in the up and down direction (corresponding to a third direction).

Brake pipes 2 are connected with master cylinder ports PMC of pressure control unit 1. Brake pipes 3 are connected with wheel cylinder ports PWC. Brake pipes 2 and 3 are rigid tubes which are steel pipes in this example. Therefore, these rigid pipes 2 and 3 function to fix the position of pressure control unit 1 with respect to master cylinder M/C and wheel/cylinders W/C. Therefore, pressure control unit 1 is supported also by these rigid pipes 2 and 3.

(Position of Sensing Section) In the up and down direction (or vertical direction), the vehicle motion variable sensing section 22 (serving as the physical quantity sensor) is located above the level of the axis of piston pump 4. As shown in FIG. 4A, the pump axis of piston pump 4 (4P and 4S) and the motor axis L of motor 15 are on the same level. Therefore, the pump axis and the motor axis L are coplanar and perpendicular to each other in an imaginary (horizontal) reference plane. The sensing section 22 is located above this reference plane. The pump axis can be defined as an imaginary straight line in which P side pump 4P and S side pump 4S are aligned. Thus, the axes of the pistons 42 of P side pump 4P and S side pump 4S are substantially collinear on the same pump axis.

In the horizontal or lateral layout shown in FIG. 4B as viewed from below, the vehicle motion variable sensing section 22 is located within an imaginary triangle formed by a first imaginary line or virtual line VL connecting the position of second mount portion 32c with the position of one of the first mount portions 31d, and a second imaginary or virtual line VL connecting the position of second mount portion 32c with the position of the other of the first mount portions 31d, and the position of vehicle motion variable sensing section 22 is located on the axis L of motor 15. Moreover, the piston pump 4 and the center of gravity G of pressure control unit 1 are located in the triangle formed between the imaginary lines VL. The vehicle motion variable sensing section 22 is located between the second mount portion 32c and the center of gravity G (along the motor axis L in this example). Furthermore, the vehicle motion variable sensing section 22 is located between the second mount portion 32c and the piston pump 4 (along the motor axis L in this example). In the horizontal layout shown in FIG. 4B, the imaginary triangle is substantially an isosceles triangle having a base between the first mount portions 31d and two equal sides which diverge from the second mount portion 32c forming the apex and which are longer than the base, in the example shown in FIG. 4B.

### Operation of First Embodiment

Fluid pressure control unit 1 is an assembly of, at least, motor 15, housing unit HU, and control housing CH which are fixed together as an integral unit. Therefore, the vehicle motion variable sensing section 22 (serving as the physical quantity sensor) may produce sensing errors due to vibrations transmitted from motor 15 and pump 4 in operation.

Control board CB is received in control cover CH2. Control housing CH and motor 15 are fixed to housing unit HU on the opposite sides. Motor 15 is on the first (left) side of housing unit HU whereas control housing CH is on the second (right) side opposite to the first side as shown in FIG. 4A. The center of gravity G of pressure control unit 1 is located on the first (left) side because motor 15 is heavier than control housing CH. Therefore, the sensing section 22 is located far from the center of gravity G. Vibrations caused by the driving operations of motor 15 and piston pump 4 may be transmitted with greater displacement or amplitude of the vibrations, and may cause errors in the sensing operation of sensing section 22.

Therefore, in the first embodiment, the sensing section 22 is located on the motor axis L in the lateral (or horizontal) layout as viewed from the bottom (as in FIGS. 4B, 5 and 6B), so that displacements due to vibrations are applied uniformly or symmetrically. As a result, this arrangement makes it easier to predict vibrations applied to sensing section 22, and make it possible to improve the output accuracy of motion variable sensing section 22.

Pressure control unit 1 includes one or more connection ports such as wheel cylinder ports PWC and master cylinder ports PMC which are all located above the reference horizontal plane defined by the motor axis L and the pump axis. A rigid tube such as steel pipes 2 and 3 is connected with the connection port or each port. In the illustrated examples, steel pipes 2 and 3 are connected, respectively, with wheel cylinder ports PWC formed in upper surface HU3 and master cylinder ports PMC formed in upper side surface HU4. Therefore, the fulcrum of vibrations is located above the center of gravity G.

Therefore, in the first embodiment, the vehicle motion variable sensing section 22 is placed above the motor axis L and above the reference plane defined by the motor axis L and the pump axis, in the up and down direction (which can correspond to the third direction). This arrangement is effective for restraining the displacement of vibrations applied to the sensing section 22.

In the lateral layout as viewed from the lower side of pressure control unit 1, the piston pump 4 is disposed in the imaginary triangle formed by the imaginary lines VL connecting the second mount portion 32c with the first mount portions 31d, and the sensing section 22 is disposed between piston pump 4 and second mount portion 32c. This arrangement can restrain vibrations of piston pump 4 with the first mount portions 31d and second mount portion 32c, and restrain vibrations applied to sensing section.

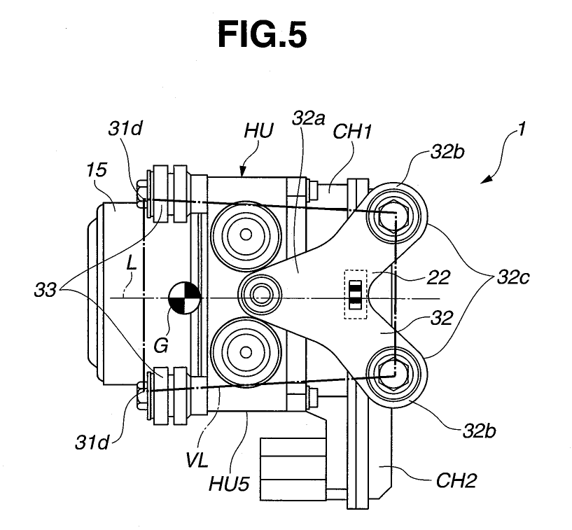

The center of gravity G is located with the imaginary triangle formed by the imaginary lines VL connecting first and second mount portions 31d and 32c in the lateral layout, and the vehicle motion variable sensing section 22 is disposed between the center of gravity G and the second mount portion 32c. This arrangement can restrain vibrations of pressure control unit 1, and restrain vibrations applied to sensing section 22.

[Variation 1] FIG. 5 shows a first variation according to the first embodiment. Pressure control unit 1 shown in FIG. 5 has two of second mount portions 32c while the pressure control unit shown in FIGS. 4A and 4B has only one second mount portion 32c.

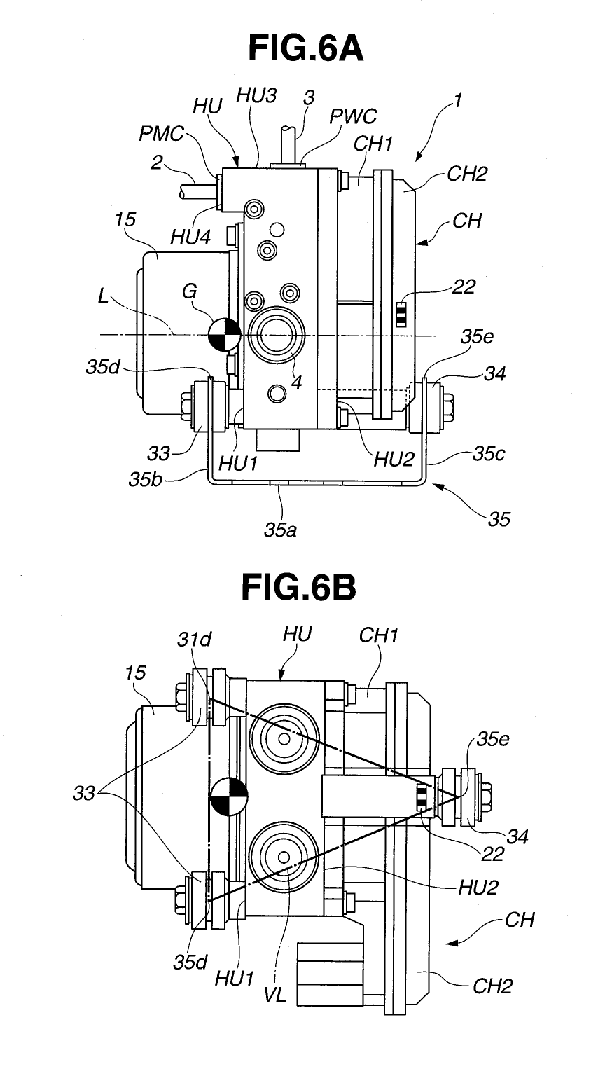

Second bracket 32 of FIG. 5 includes upper portion 32a, and two lower portions 32b extending from the upper portion 32a, in the form of bifurcation at a lower level lower than the upper portion 32a. Upper portion 32a is fixed to the lower surface HU5 of housing unit HU. Second mount portion 32c is provided at an end portion of each of the lower portions 32b. At the two second mount portions 32c, second bracket 32 is fixed to the horizontal wall portion 31b of first bracket 31 through respective mount rubber members 34. Horizontal wall portion 31b of first bracket 31 extends from a first (left) end from which vertical wall portion 31a extends upwards, to a second end from which the flange portion 31c extends downwards. The end portions of lower portions 32b of second bracket 32 are fixed to a second end portion of horizontal wall portion 31b near the second end of horizontal wall portion 31b. Each of lower portions 32b of second bracket 32 is fixed to first bracket 31 by a fastening device, such as a bolt, extending in the second supporting direction which is perpendicular or orthogonal to the first supporting direction of each of the first mount portions 31d. In the correct upright position of pressure control unit 1, the second supporting direction extends vertically (in a third direction) and the first supporting direction extends in the first direction along motor axis L.

[Second Variation] FIGS. 6A and 6B show pressure control unit 1 in a second variation of the first embodiment. In the arrangement shown in FIGS. 4A and 4B, the pressure control unit 1 is fixed to a vehicle body member by the first and second brackets 31 and 32. In the second variation of FIGS. 6A and 6B, by contrast, the pressure control unit 1 is fixed to the vehicle body member only by a single bracket 35. Furthermore, the second supporting direction is not perpendicular to the first supporting direction. Pressure control unit 1 is supported elastically at a first mount portion 35d and a second mount portion 35e both in the axial direction (L) of motor 15 (first direction).

Pressure control unit 1 is supported to the vehicle body 30 by the above-mentioned single bracket 35. This bracket 35 is U-shaped as viewed in FIG. 6A. The U-shaped bracket 35 includes a horizontal wall portion 35a extending from a first end to a second end, two first side vertical wall portions 35 extending upwards from the first end of horizontal wall portion 35a, along the first side surface HU1 of housing unit HU, and a second side vertical wall portion 35c extending upwards from the second end of the horizontal wall portion 35a, along the control cover CH2. Horizontal wall portion 35a is adapted to be welded or joined by fastening devices such as bolts, to the vehicle body 30. A first mount portion 35d is provided in an upper end portion of each of the first-side vertical wall portions 35b. At each of the first side mount portions 35d, the first side vertical wall portion 35b is fixed through an elastic support member 33 such as a mount rubber member, to the first side surface HU1 of housing unit HU. At a second mount portion 35e provided in an upper end portion of the second side vertical wall portion 35c, the second side vertical wall portion 35c is fixed through an elastic support member 34 such as a mount rubber member, to the second side surface HU2 of housing unit HU. Pressure control unit 1 is supported in the supporting direction extending along the motor axis L of motor 15 at all the mount portions 35d and 35e. In the example shown in FIG. 6A, the second mount portion 35e is located at the same level as the first mount portions 35d in the up and down direction.

### Effect of the First Embodiment

(1) A hydraulic apparatus includes at least a fluid pressure control unit which includes at least: a housing unit (HU) enclosing a pump (such as piston pump 4), and including first and second opposite side surfaces (such as side surfaces HU1 and HU2); a motor being fixed to the first side surface and including a motor shaft to drive the pump; a control board disposed on the second side and arranged to control the motor; a cover covering the control board; a physical quantity sensing section mounted on the control board and arranged to sense a physical quantity such as a vehicle motion variable; and first and second mount portions to support the housing unit elastically to a support member such as a vehicle body. The physical quantity sensing section is disposed between the first and second mount portions in a space formed between the housing unit and the cover. Therefore, this hydraulic apparatus can restrain vibrations applied to the physical quantity sensing section by operation of the fluid pressure control unit, and thereby reduce errors in the physical quantity sensing section.

(2) In the illustrated examples of the first embodiment, the pump is a piston pump having a piston moving back and force in a piston axial direction (which can correspond to a second direction). The piston pump produces vibrations along the piston axis. Therefore, the estimation of vibrations is easier, and the apparatus can improve the output accuracy of the physical quantity sensing section.

In the illustrated examples, moreover, the piston axis extends between the first and second side surfaces HU1 and HU2 (which are substantially flat and parallel to each other), along the first and second side surfaces HU1 and HU2, in a second direction orthogonal to a first direction along the motor axis L. The control board CB extends along the second side surface HU2 on the second side, and has a first side surface facing to the second side surface HU2 of housing unit HU and a second side surface facing away from the second side surface HU2. In FIG. 2, the first side surface of control board CB is a left side surface, and the second side surface of control board CB is a right side surface. In the illustrated example, the sensing section 22 is fixed to the second side surface of control board CB, and disposed between control board CB and cover CH2, in the motor axis direction (L) (corresponding to the first direction).

(3) Rigid tubes such as steel pipes 2 and 3 are connected to a master cylinder port PMC and a wheel cylinder port PWC formed in an upper portion of the housing unit HU above the piston axis of pump 4, or above an imaginary horizontal reference plane containing the motor axis and piston axis which are perpendicular to each other in the imaginary horizontal reference plane (which can correspond to a second imaginary reference plane). Moreover, the vehicle motion variable sensing section 22 is disposed above the piston axis, or above the imaginary horizontal reference plane. In the illustrated examples, the position of vehicle motion variable sensing section 22 is near the imaginary horizontal plane, and lower than each of the positions of the ports PMC and PWC.

The rigid tubes 2 and 3 function to hold the pressure control unit 1 stationary, and thereby to support the upper portion of pressure control unit 1. Vibrations are produced so that a supporting point is above the piston axis, and this arrangement can restrain the amplitude of vibrations applied to vehicle motion variable sensing section 22.

(4) In a bottom view (or lateral or horizontal layout) as viewed from a lower side of the pressure control unit 1 in the state of installation in a vehicle, the piston pump 4 (or the center position of piston pump 4) is located within an angle formed by a first imaginary straight line VL extending from the position of second side mount portion 32c to one of the first side mount portions 31d and a second imaginary straight line VL extending from the position of second side mount portion 32c to the other of the first side mount portions 31d, and the motion variable sensing section 22 is located between the piston 4 and the position of second side mount portion 32c. Therefore, the first side and second side mount portions 31d and 32c can function to restrain vibrations of piston pump 4, and to restrain vibrations applied to sensing section 22.

(5) Two first side mount portions 31d are provided on the first side surface HU1 to which motor 15 is fixed. Each of the first side mount portions 31d includes a support shaft (such as a bolt) extending in a first supporting direction (along the motor axis L). The single second side mount portion 32c is arranged to elastically support the lower surface HU5 of housing unit HU to the vehicle body. Second side mount portion 32c includes a first portion fixed to the vehicle body directly or through a first bracket (31), a second portion fixed to the lower surface HU5 of housing unit HU directly or through a second bracket (32), and an elastic member disposed between the first and second portions, for supporting the lower surface of housing unit HU elastically. Second side mount portion 32c includes a support shaft (such as a bolt) extending in a second supporting direction orthogonal to the first supporting direction. In the illustrated examples, the first supporting direction is the first direction along the motor axis L, the second supporting direction is the third direction extending vertically (in the up and down direction) in the state of installation in a vehicle.

Accordingly, it is possible to place the vehicle motion variable sensing section 22 within an imaginary polygon formed by the positions of first-side and second-side mount portions, to the advantage of reducing vibrations applied to the sensing section 22, and reducing errors in the sensing section 22. The first side mount portions 31d can reduce vibrations in the first direction along the motor axis L with elastic members (33) oriented to provide elasticity most effectively in the first direction. The second-side mount portion 32c can reduce vibrations in the second support direction orthogonal to the first direction, with an elastic member (34) oriented to provide elasticity most effectively in the second support direction. This arrangement contributes to the reduction of errors in the sensing section 22.

In the example shown in FIG. 4A, the position or level of second-side mount portion 32c is lower than the position or level of the first-side mount portions 31d in the up and down direction (which can correspond to the third direction).

(6) The mount portions are arranged so that a center-of-gravity line (G) of the pressure control unit lies between the position of first side mount portions 31d and the position of second-side mount portion 32c. Therefore, the center of gravity G of pressure control unit 1 can be supported by the first-side and second-side mount portions 31d and 32c. This arrangement can reduce vibrations in pressure control unit 1, and reduce sensing errors in the sensing section 22. In the illustrated examples, the center of gravity G is located between the position of first side mount portions 31d and the first side surface HU1 of housing unit HU.

(7) The vehicle motion variable sensing section 22 is disposed on an extension of the motor axis L in the bottom view as viewed from the lower side of the housing unit. Therefore, vibrations of pump 4 is applied substantially in a symmetrical, uniform and predictable manner. This arrangement can improve the output accuracy of vehicle motion variable sensing section 22. The motion variable sensing section (22) which can correspond to physical quantity sensor) is located at a sensor position lying on a first (vertical) imaginary reference plane containing the motor axis and extending in a third direction which is orthogonal to the first and second directions and which is the up and down direction.

(8) The vehicle motion variable sensing section 22 is disposed between the center-of-gravity line and the second mount portion. This arrangement can reduce vibrations of pressure control unit 1, and reduce sensing errors in the sensing section 22.

(9) Housing unit HU is supported to a support member such as a member of a vehicle body through first and second brackets 31 and 32 and through elastic support members. This supporting structure can restrain vibrations in pressure control unit 1, and reduce sensing errors in the sensing section 22.

(10) The pressure control unit is a brake fluid pressure control unit which further comprises an electromagnetic valve to control a brake fluid pressure; the control section is configured to control the motor and the electromagnetic valve; the physical quantity (vehicle motion variable) sensor includes a yaw rate sensor; and the yaw rate sensor is located between the mount portions. Therefore, the arrangement can reduce vibrations applied to the sensing section and restrain sensing errors in the sensing section.

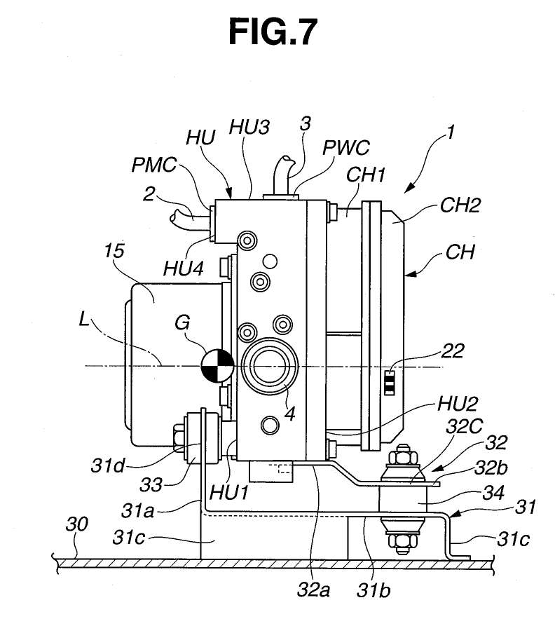

FIG. 7 shows hydraulic apparatus according to a second embodiment of the present invention. FIG. 7 is a side view as viewed in the direction along the pump axis of piston pump 4, for showing the support structure.

In the second embodiment, flexible hoses are used as tubes 2 and 3 instead of the rigid steel pipes of the first embodiment. Moreover, the motion variable sensing section 22 is disposed below the position of the pump axis of piston pump 4.

The fluid pressure control unit includes an upper portion formed with at least one connection port (such as PMC and PWC) connected with a flexible tube for connecting the connection port with an external hydraulic device (such as a master cylinder (M/C) or a wheel cylinder (W/C)). The connection port is located above the axis of the pump whereas the physical quantity (or vehicle motion variable) sensor is located below the axis of the pump in the up and down direction. The flexible hoses can not function to support the pressure control unit 1, so that the supporting point of vibrations is located below the center of gravity G.

This arrangement in which the vehicle motion variable sensing section 22 is positioned below the level of piston pump 4 in the up and down direction is effective for restraining vibrations applied to the vehicle motion variable sensing section 22.

### Effect of Second Embodiment

(11) Flexible tubes are connected to a master cylinder port PMC and a wheel cylinder port PWC formed in an upper portion of the housing unit HU above the piston axis of pump 4. Moreover, the vehicle motion variable sensing section 22 is disposed below the piston axis, or below the imaginary horizontal reference plane containing the motor axis. In the illustrated example, the position of vehicle motion variable sensing section 22 is near the imaginary horizontal reference plane, and higher than the level of each of the mount portions as shown in FIG. 7.

The flexible tubes 2 and 3 cannot function to support the pressure control unit 1. Vibrations are produced so that a supporting point is below the center of gravity G of pressure control unit 1. This arrangement reduces vibrations applied to the vehicle motion variable sensing section, and restrains sensing errors in vehicle motion variable sensing section.

According to the illustrated embodiments, a basic construction of hydraulic apparatus comprises: a housing unit including a pump (such as a piston pump), a first side surface on a first lateral side (such as the left side as viewed in FIG. 2), a second side surface on a second lateral side opposite to the first side, an upper surface facing upwards when the housing unit is placed in a predetermined posture, and a lower surface facing downwards in the predetermined posture; a motor which is fixed to the first side surface of the housing unit and which includes a rotary member rotating about a motor axis extending in a first direction, to drive the pump; a second-side section fixed to the second side surface of the housing unit and including a control section to control the motor and a physical quantity sensor to sense a physical quantity; and first and second side mounting devices. The first side mounting device (such as 31d or 35d) is arranged to support the housing unit elastically on the first side and the second side mounting device (such as 32c or 35e) is arranged to support the housing unit elastically on the second side. At least one of the first and second side mounting devices is arranged to support the housing unit at two separate mount points which are spaced apart from each other in a second direction perpendicular to a first imaginary plane containing the motor axis and extending in a third direction (which may be an up and down direction). The physical quantity sensor (such as a vehicle motion variable sensor or a yaw rate sensor) is located, in the first direction (L), between the first side mounting device (31d; 35d) and the second side mounting device, and located, in the second direction, between the separate mount points on both sides of the first imaginary plane. The second side section fixed to the second side surface of the housing unit may further include a control housing (CH, 21, CH1) and a control cover (CH2) covering the control section. Each of the first and second side mounting devices may includes an elastic support member (such as rubber mount members 33 and 34), and a fastening device (such as a bolt).

In the above-mentioned basic construction of the hydraulic apparatus, the physical quantity sensor may be located at a sensor position lying on the first (vertical) imaginary plane containing the motor axis and extending in the third (up and down) direction which is orthogonal to the first and second directions. Moreover, the sensor position of the physical quantity sensor may be away from the second imaginary plane. In the examples shown in FIG. 4A and FIG. 6A, the sensor position of the physical quantity sensor is above the second (horizontal) imaginary plane.

According to one aspect of the present invention, a hydraulic brake pressure control apparatus for a vehicle, comprises a housing including a first side surface (HU1) and a second side surface (HU2) opposite to the first side surface; pumping means disposed in the housing, for producing a brake pressure; driving means fixed to the first side surface of the housing, for driving the pumping means; controlling means fixed to the second side of the housing, for controlling the driving means; sensing means mounted on the controlling means at a sensor point, for sensing a vehicle motion variable of the vehicle; and supporting means for supporting the housing to a vehicle body elastically at a plurality of mount points so that the sensor point is located between the mount points. Mount portions (31d, 32c; 35d, 35e) can serve as the supporting means. Control section CB can serve as a main component of the controlling means. The sensing means may include a vehicle motion variable sensor for sensing one or more of vehicle yaw rate, vehicle longitudinal acceleration and vehicle lateral acceleration. The driving means may include an electric motor, and the pumping means may include a pump. The hydraulic brake pressure control apparatus may further comprise covering means (such as CH2) covering the controlling means. The pumping means may include eccentric drive means (such as 40) for translating rotation of the driving means into a linear motion. The hydraulic brake pressure control apparatus may further comprise means for determining the position of the sensor point.

This application is based on a prior Japanese Patent Application No. 2007-120946 filed on May 1, 2007. The entire contents of this Japanese Patent Application No. 2007-120946 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A hydraulic apparatus comprising a fluid pressure control unit which comprises:
a housing unit enclosing a pump, and including a first side surface on a first side, and a second side surface on a second side opposite to the first side;
a motor fixed to the first side surface of the housing unit and arranged to drive the pump;
a control section disposed on the second side of the housing unit and arranged to control the motor;
a cover covering the control section;
a physical quantity sensor fixed to the control section, placed between the housing unit and the cover, and arranged to sense a physical quantity of a vehicle; and
a plurality of mount portions to support the housing unit to a vehicle body elastically, the physical quantity sensor being located between the mount portions.

2. The hydraulic apparatus as claimed in claim 1, wherein the pump is a piston pump including a cam fixed to a motor shaft of the motor, and a piston arranged to reciprocate in accordance with motion of the cam.

3. The hydraulic apparatus as claimed in claim 2, wherein the hydraulic apparatus further comprises a flexible tube; the fluid pressure control unit further includes a connection port connected with the flexible tube for connecting the connection port with a hydraulic device; and the connection port is located above the pump whereas the physical quantity sensor is located below the pump.

4. The hydraulic apparatus as claimed in claim 2, wherein the hydraulic apparatus further comprises a rigid tube; the fluid pressure control unit further includes a connection port connected with the rigid tube for connecting the connection port with a hydraulic device; and the connection port is located above the pump and the physical quantity sensor is also located above the pump.

5. The hydraulic apparatus as claimed in claim 1, wherein the physical quantity sensor is located within an imaginary polygon formed by imaginary lines connecting the mount portions in a bottom view as viewed from a lower side of the housing unit in a state in which the housing unit is to be installed in a vehicle.

6. The hydraulic apparatus as claimed in claim 5, wherein the physical quantity sensor is disposed on an extension of an axis of the motor in the bottom view as viewed from the lower side of the housing unit.

7. The hydraulic apparatus as claimed in claim 5, wherein the mount portions comprises two first mount portions supporting the first side surface of the housing unit in a first supporting direction extending along an axis of the motor and a second mount portion supporting a bracket projecting from a lower surface of the housing unit, in a second supporting direction orthogonal to the first supporting direction.

8. The hydraulic apparatus as claimed in claim 7, wherein the mount portions are arranged so that a center-of-gravity line of the pressure control unit lies between the mount portions.

9. The hydraulic apparatus as claimed in claim 8, wherein the physical quantity sensor is disposed between the center-of-gravity line and the second mount portion.

10. The hydraulic apparatus as claimed in claim 9, wherein the pump is a piston pump including a piston reciprocating along a pump axis.

11. The hydraulic apparatus as claimed in claim 10, wherein the hydraulic apparatus further comprises a flexible tube; the fluid pressure control unit further includes a connection port connected with the flexible tube for connecting the connection port with a hydraulic device which is one of a master cylinder and a wheel cylinder; and the connection port is located above the pump axis of the pump whereas the physical quantity sensor is located below the pump axis of the pump.

12. The hydraulic apparatus as claimed in claim 10, wherein the hydraulic apparatus further comprises a rigid tube; the fluid pressure control unit further includes a connection port connected with the rigid tube for connecting the connection port with a hydraulic device which is one of a master cylinder and a wheel cylinder; and the connection port is located above the pump axis of the pump and the physical quantity sensor is also located above the pump axis of the pump.

13. The hydraulic apparatus as claimed in claim 10, wherein the physical quantity sensor is disposed between the pump axis of the pump and the second mount portion.

14. The hydraulic apparatus as claimed in claim 1, wherein the pressure control unit is a brake fluid pressure control unit which further comprises an electromagnetic valve to control a brake fluid pressure; the control section is configured to control the motor and the electromagnetic valve; the physical quantity sensor includes a yaw rate sensor; and the yaw rate sensor is located among the mount portions.

15. A hydraulic apparatus comprising:
a housing unit including a pump, a first side surface on a first side, and a second side surface on a second side opposite to the first side;
a motor which is fixed to the first side surface of the housing unit and which includes a rotary member rotating about a motor axis extending in a first direction, to drive the pump;
a second side section fixed to the second side surface of the housing unit and including a control section to control the motor and a physical quantity sensor disposed on the second side of the housing unit and arranged to sense a physical quantity; and
a pair of a first side mounting device to support the housing unit elastically on the first side and a second side mounting device to support the housing unit elastically on the second side, at least one of the first and second side mounting devices being arranged to support the housing unit at two separate mount points which are spaced apart from each other in a second direction perpendicular to a first imaginary plane containing the motor axis, the physical quantity sensor being located, in the first direction, between the first side mounting device and the second side mounting device, and located, in the second direction, between the separate mount points on both sides of the first imaginary plane.

16. The hydraulic apparatus as claimed in claim 15, wherein the physical quantity sensor is located at a sensor position lying on the first imaginary plane containing the motor axis and extending in a third direction which is orthogonal to the first and second directions and which is an up and down direction.

17. The hydraulic apparatus as claimed in claim 16, wherein the hydraulic apparatus is hydraulic apparatus for a vehicle brake system, the housing unit includes a master cylinder port to be connected with a master cylinder and a wheel cylinder port to be connected with a wheel cylinder; the master cylinder port and the wheel cylinder port are located above a second imaginary plane containing the motor axis and extending in the second direction; and the first and second side mounting devices are located below the second imaginary plane.

18. The hydraulic apparatus as claimed in claim 17, wherein the sensor position of the physical quantity sensor is away from the second imaginary plane.

19. The hydraulic apparatus as clamed in claim 18, wherein the first side mounting device includes a first elastic support member supporting the housing unit elastically in a first elastic support direction, the second side mounting device includes a second elastic support member supporting the housing unit elastically in a second elastic support direction orthogonal to the first elastic support direction.

20. The hydraulic apparatus as clamed in claim 19, wherein the positions of the first side mounting device and the second side mounting device are spaced apart in the third direction.

21. A hydraulic brake apparatus for a vehicle, comprising a brake fluid pressure control unit which comprises:
a housing including a first side surface and a second side surface opposite to the first side surface;
pumping means disposed in the housing, for producing a brake pressure to be supplied to a wheel cylinder of the vehicle;
driving means fixed to the first side surface of the housing, for driving the pumping means;
controlling means fixed to the second side of the housing, for controlling the driving means;
sensing means mounted on the controlling means at a sensor point, for sensing a vehicle motion variable of the vehicle; and
supporting means for supporting the housing to a vehicle body elastically at a plurality of mount points so that the sensor point is located between the mount points.

22. The hydraulic apparatus as clamed in claim 21, wherein positions of the mount points in a predetermined imaginary reference plane are arranged to form an imaginary convex polygon in the imaginary reference plane so that the sensor point is located within the imaginary convex polygon.
